(19) United States
(12) Patent Application Publication
(10) Pub. No.: US 2025/0358568 A1
(43) Pub. Date: Nov. 20, 2025

(54) NOISE CONTROL METHOD AND APPARATUS, CHIP, AND VEHICLE

(71) Applicant: XG TECH PTE. LTD., Singapore (SG)

(72) Inventors: Tianyi ZHU, Singapore (SG); Jincheng GU, Singapore (SG); Yang LIU, Singapore (SG)

(73) Assignee: XG TECH PTE. LTD., Singapore (SG)

(21) Appl. No.: 19/281,854

(22) Filed: Jul. 28, 2025

(30) Foreign Application Priority Data
Feb. 11, 2025 (CN) 202510154735.8

(51) Int. Cl. H04R 3/02

(52) U.S. Cl. CPC H04R 3/02; H04R 2499/13

(57) ABSTRACT

Disclosed are a noise control method and apparatus, a chip, and a vehicle. The method includes: acquiring at least one first reference acoustic signal and at least one error acoustic signal that correspond to a first noise reduction cycle; transmitting the at least one first reference acoustic signal and the at least one error acoustic signal to a second processing unit; updating filter parameters based on the at least one first reference acoustic signal and the at least one error acoustic signal to obtain first filter parameters, and returning the same to the first processing unit; and performing, based on the first filter parameters, filtering processing on at least one second reference acoustic signal corresponding to a second noise reduction cycle to obtain at least one noise control signal, and correspondingly transmitting the same to at least one sound source corresponding to the at least one second position.

### CROSS-REFERENCE TO RELATED APPLICATION

The present disclosure claims priority to Chinese Patent Application No. 202510154735.8 filed on Feb. 11, 2025, which is incorporated herein by reference in its entirety.

### TECHNICAL FIELD

The present disclosure relates to the fields of information processing technologies and vehicle noise control technologies, and in particular, to a noise control method and apparatus, a chip, and a vehicle.

### BACKGROUND

A vehicle may encounter various road conditions during traveling, resulting in loud noise inside the vehicle. Even though sound-absorbing cotton and a vibration-proof pad are used in the vehicle to reduce noise generation and transmission, a requirement of a consumer for noise control in the vehicle cannot be satisfied. Therefore, active noise control technologies rise to the occasion.

In the related technology, to control road noise originating from vibration of a vehicle body structure, a road noise control (RNC) system adaptively generates and plays a control signal to cancel the road noise, aiming to minimize a noise level at ears of a passenger in a cabin, based on a signal, as a reference signal, from an accelerometer sensor arranged on the vehicle body. Due to a wide frequency range of the road noise to be controlled and a relatively large number of channels for acquiring the reference signal and channels (loudspeakers) for outputting the control signal, a control algorithm for the RNC system is highly complex, and the demand for computing power of the system is also very high.

How to meet the demand for the computing power of the RNC system has become a technical problem that needs to be resolved urgently.

### SUMMARY

Embodiments of the present disclosure provide a noise control method and apparatus, a chip, and a vehicle.

According to one aspect of embodiments of the present disclosure, there is provided a noise control method, including: acquiring, by a first processing unit, at least one first reference acoustic signal and at least one error acoustic signal that correspond to a first noise reduction cycle, where the at least one first reference acoustic signal is a noise signal acquired from at least one first position on a vehicle, and the at least one error acoustic signal is a noise residual signal acquired from at least one second position in a cockpit of the vehicle; transmitting, by the first processing unit, the at least one first reference acoustic signal and the at least one error acoustic signal to a second processing unit; updating, by the second processing unit, filter parameters based on the at least one first reference acoustic signal and the at least one error acoustic signal to obtain first filter parameters, and returning the first filter parameters to the first processing unit; and performing, by the first processing unit based on the first filter parameters, filtering processing on at least one second reference acoustic signal corresponding to a second noise reduction cycle to obtain at least one noise control signal, and correspondingly transmitting the at least one noise control signal to at least one sound source corresponding to the at least one second position, so that the at least one sound source plays the corresponding noise control signal, where the second noise reduction cycle is a noise reduction cycle immediately after the first noise reduction cycle.

According to another aspect of the embodiments of the present disclosure, there is provided a noise control apparatus, including: a first processing unit and a second processing unit, where the first processing unit and the second processing unit are connected to each other through an inter-core communication link; the first processing unit is configured for acquiring at least one first reference acoustic signal and at least one error acoustic signal that correspond to a first noise reduction cycle, where the at least one first reference acoustic signal is a noise signal acquired from at least one first position on a vehicle, and the at least one error acoustic signal is a noise residual signal acquired from at least one second position in a cockpit of the vehicle; the first processing unit is configured for transmitting the at least one first reference acoustic signal and the at least one error acoustic signal to the second processing unit; the second processing unit is configured for updating filter parameters based on the at least one first reference acoustic signal and the at least one error acoustic signal to obtain first filter parameters, and returning the first filter parameters to the first processing unit; and the first processing unit is configured for performing, based on the first filter parameters, filtering processing on at least one second reference acoustic signal corresponding to a second noise reduction cycle to obtain at least one noise control signal, and correspondingly transmitting the at least one noise control signal to at least one sound source corresponding to the at least one second position, so that the at least one sound source plays the corresponding noise control signal, where the second noise reduction cycle is a noise reduction cycle immediately after the first noise reduction cycle.

According to another aspect of the embodiments of the present disclosure, there is provided a chip, including a first processing unit and a second processing unit, where the first processing unit and the second unit are connected to each other through an inter-core communication link; the first processing unit is configured for acquiring at least one first reference acoustic signal and at least one error acoustic signal that correspond to a first noise reduction cycle, where the at least one first reference acoustic signal is a noise signal acquired from at least one first position on a vehicle, and the at least one error acoustic signal is a noise residual signal acquired from at least one second position in a cockpit of the vehicle; the first processing unit is configured for transmitting the at least one first reference acoustic signal and the at least one error acoustic signal to the second processing unit; the second processing unit is configured for updating filter parameters based on the at least one first reference acoustic signal and the at least one error acoustic signal to obtain first filter parameters, and returning the first filter parameters to the first processing unit; and the first processing unit is configured for performing, based on the first filter parameters, filtering processing on at least one second reference acoustic signal corresponding to a second noise reduction cycle to obtain at least one noise control signal, and correspondingly transmitting the at least one noise control signal to at least one sound source corresponding to the at least one second position, so that the at least one sound source plays the corresponding noise control signal, where the second noise reduction cycle is a noise reduction cycle immediately after the first noise reduction cycle.

According to another aspect of the embodiments of the present disclosure, there is provided a vehicle, including a vehicle body, at least one first sensor, at least one second sensor, at least one sound source, and the noise control apparatus described above or the chip described above, where the at least one first sensor is deployed in the at least one first position on the vehicle body; the at least one second sensor is deployed in the at least one second position in the vehicle body; and the at least one sound source is deployed in the at least one second position in the vehicle body.

Based on the foregoing embodiments of the present disclosure, in a noise control system, a first processing unit acquires at least one first reference acoustic signal and at least one error acoustic signal that correspond to a first noise reduction cycle, and transmits the at least one first reference acoustic signal and the at least one error acoustic signal to a second processing unit; the second processing unit updates filter parameters based on the at least one first reference acoustic signal and the at least one error acoustic signal to obtain and return first filter parameters to the first processing unit; and thereby the first processing unit may perform, by using the first filter parameters, filtering processing on at least one second reference acoustic signal acquired within a second noise reduction cycle to obtain at least one noise control signal, and correspondingly transmits the at least one noise control signal to at least one sound source corresponding to the at least one second position, so that the at least one sound source plays the corresponding noise control signal to achieve noise control. In this way, in the technical solution of the present disclosure, noise control is achieved by the combination of the first processing unit and the second processing unit, thereby effectively expanding available computing power of the noise control system, and improving reliability and robustness of noise control. In addition, because the second processing unit has a relatively low unit computing power cost and is highly reusable, the implementation of some algorithms in noise control is migrated to the second processing unit, for example, filter parameter updating with a relatively low requirement for real-time performance is implemented by using the second processing unit, which helps reduce the cost of the noise control system. Meanwhile, signal filtering and output are implemented by using the first processing unit, which may ensure high real-time performance and a noise reduction effect of noise control.

The technical solutions of the present disclosure are further described in detail below through accompanying drawings and embodiments.

### BRIEF DESCRIPTION OF DRAWINGS

FIG. 1 is a diagram of a noise control system to which the present disclosure is applicable.

FIG. 2 is a schematic flowchart illustrating a noise control method according to an exemplary embodiment of the present disclosure.

FIG. 3 is a schematic flowchart illustrating a noise control method according to another exemplary embodiment of the present disclosure.

FIG. 4 is a schematic flowchart illustrating filter parameter update in a noise control method according to another exemplary embodiment of the present disclosure.

FIG. 5 is a schematic block diagram illustrating a structure of a noise control apparatus according to an exemplary embodiment of the present disclosure.

FIG. 6 is a schematic block diagram illustrating a structure of a noise control apparatus according to another exemplary embodiment of the present disclosure.

FIG. 7 is a schematic block diagram illustrating a structure of a chip for noise control according to another exemplary embodiment of the present disclosure.

FIG. 8 is a schematic diagram illustrating a vehicle with a noise control function according to another exemplary embodiment of the present disclosure.

FIG. 9 is a schematic block diagram illustrating a structure of an electronic device according to an exemplary embodiment of the present disclosure.

### DETAILED DESCRIPTION OF THE EMBODIMENTS

Exemplary embodiments of the present disclosure are described below in detail with reference to accompanying drawings. Obviously, the described embodiments are merely a part, rather than all, of embodiments of the present disclosure. It should be understood that the present disclosure is not limited by the exemplary embodiments described herein.

It should be noted that, unless otherwise specified, the scope of the present disclosure is not limited by relative arrangement, numeric expressions, and numerical values of components and steps described in these embodiments.

A person skilled in the art may understand that, terms such as “first” and “second” in the embodiments of the present disclosure are used only to distinguish between different steps, devices, modules, or the like, neither representing any specific technical meaning, nor representing any necessary logical sequence between them.

It should be further understood that, in the embodiments of the present disclosure, “a plurality of” may refer to two or more, and “at least one” may refer to one, two, or more.

It should be further understood that any component, data, or structure mentioned in the embodiments of the present disclosure can be generally understood as one or more components, data, or structures in the absence of an explicit limitation or contrary indications given in the context.

In addition, the term “and/or” in the present disclosure describes only an association relationship for describing associated items, representing that there may be three relationships. For example, A and/or B may represent the following three cases: Only A, both A and B, and only B. In addition, the symbol “/” in the present disclosure generally indicates an “or” relationship between the associated items.

It should be further understood that, the description of the embodiments in the present disclosure focuses on differences between the embodiments, and the sameness or similarities therebetween can be referred to each other. For brevity, details are not repeated one by one.

In addition, it should be noted that, for ease of description, dimensions of various parts shown in the accompanying drawings are not drawn to actual scale.

The following descriptions of a plurality of exemplary embodiments are merely illustrative, and in no way put any limitation on the present disclosure and the application or use thereof.

Techniques, methods, and devices known to a person of ordinary skill in the art may not be discussed in detail, but where appropriate, such techniques, methods, and devices should be considered as part of this specification.

It should be noted that: similar reference signs in the following accompanying drawings represent similar items, so that once an item is defined in one accompanying drawing, it is not necessary to further discuss about the item in subsequent accompanying drawings.

The embodiments of the present disclosure are applicable to a terminal device, a computer system, a server, or other electronic devices, and can be operated together with numerous other general-purpose or special-purpose computing system environments or configurations. Examples of well-known terminal devices, computing systems, environments, and/or configurations suitable for use together with the terminal device, the computer system, the server, and other electronic devices include, but are not limited to: personal computer systems, server computer systems, thin clients, thick clients, handheld or laptop devices, microprocessor-based systems, set top boxes, programmable consumer electronics, network personal computers, small computer systems, mainframe computer systems, distributed cloud computing technology environments including any of the foregoing systems, or the like.

The terminal device, the computer system, the server, and other electronic devices may be described in the general context of computer system executable instructions (such as program modules) executed by the computer system. Usually, a program module may include a routine, a program, a target program, a component, logic, a data structure, and the like, which perform specific tasks or implement specific abstract data types. The computer system/server may be implemented in a distributed cloud computing environment. In the distributed cloud computing environment, a task is performed by a remote processing device linked through a communication network. In the distributed cloud computing environment, the program module may be located on a local or remote computing system storage medium that includes a storage device.

### Overview of Disclosure

In a process of implementing technical solutions of the present disclosure, the inventors found through research that, when an RNC system determines to play a control signal based on a signal, as a reference signal, acquired by an accelerometer sensor arranged on a vehicle body, a requirement on a control algorithm for the RNC system is relatively high due to a relatively large amount of data to be processed. In the related art, an RNC system is deployed on a digital signal processor (DSP). When available computing power of the DSP on which the RNC system is deployed encounters a bottleneck, neither the effect nor the real-time performance of noise control can be ensured.

To expand the available computing power of the noise control system and ensure high real-time performance and the noise reduction effect of noise control, the inventors proposed the technical solutions of the present disclosure.

### Exemplary System

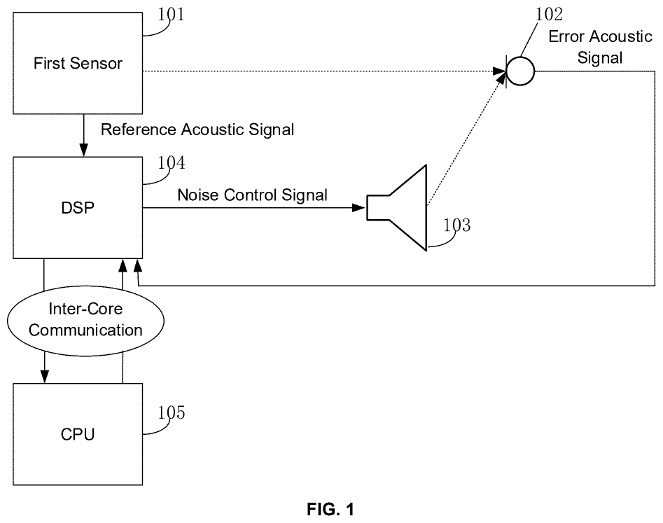

FIG. 1 illustrates a noise control system 100 applicable to a noise control method and applying an embodiment of the present disclosure.

As shown in FIG. 1, the noise control system 100, applied for noise generated in a traveling process of a vehicle, includes a first sensor 101, a second sensor 102, a sound source 103, a DSP 104, and a central processing unit (CPU) 105.

The first sensor 101 is a sensor for acquiring a reference acoustic signal, including an accelerometer sensor or a microphone array deployed at a position on a vehicle chassis or a position on an engine compartment on a vehicle body, and is configured for acquiring, in real time, a noise signal generated by vibration of the vehicle body or an engine in the traveling process of the vehicle. After acquiring the reference acoustic signal, the first sensor 101 transmits the acquired reference acoustic signal to the DSP 104. The reference acoustic signal may include road noise generated in the traveling process of the vehicle, including, for example, noise generated by the contact between a tire and the ground, and/or noise generated by the tire itself, and/or noise of the engine.

The second sensor 102 is a sensor for acquiring an error acoustic signal. The second sensor 102 includes an audio signal acquisition sensor deployed in a cockpit of the vehicle, for example, a microphone deployed in the cockpit close to a human ear. The error acoustic signal acquired by the second sensor 102 is a noise residual signal obtained by superimposing a noise control signal and the noise signal acquired in the vehicle. The noise control signal is a signal, for controlling noise in the vehicle, obtained by performing filtering processing on the reference acoustic signal acquired by the first sensor 101. After acquiring the error acoustic signal, the second sensor 102 transmits the acquired error acoustic signal to the DSP 104.

The sound source 103 is a player for playing the noise control signal, including a headrest loudspeaker deployed in the cockpit of the vehicle or an in-vehicle loudspeaker deployed in the vehicle. After receiving the noise control signal transmitted from the DSP 104, the sound source 103 plays the noise control signal.

After acquiring a reference acoustic signal and an error acoustic signal that correspond to a first noise reduction cycle, the DSP 104 transmits the reference acoustic signal and the error acoustic signal to the CPU 105. The CPU 105 updates filter parameters based on the reference acoustic signal and the error acoustic signal that correspond to the first noise reduction cycle to obtain and return first filter parameters to the DSP 104. The DSP 104 performs, based on the first filter parameters, filtering processing on a reference acoustic signal corresponding to a second noise reduction cycle to obtain a noise control signal, and correspondingly transmits the noise control signal to the sound source 103, so that the sound source 103 plays the corresponding noise control signal, where the second noise reduction cycle is a noise reduction cycle immediately after the first noise reduction cycle.

The DSP 104 and the CPU 105 may be integrated into one chip, or may be arranged in separate chips or circuit boards, between which communication may be performed through inter-core communication.

Numbers of first sensors 101, second sensors 102, sound sources 103, DSPs 104, and CPUs 105 provided in this embodiment of the present disclosure are only exemplary. According to actual needs, at least two first sensors 101, second sensors 102, sound sources 103, DSPs 104, and CPUs 105 may be provided.

### Exemplary Method

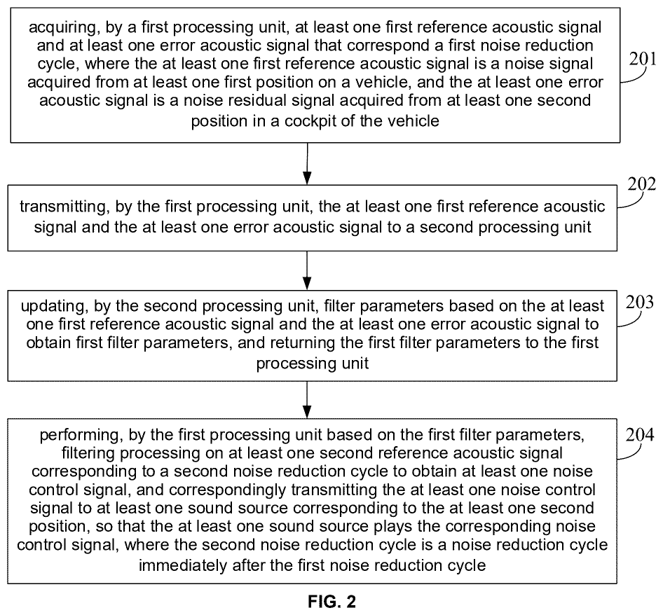

FIG. 2 is a schematic flowchart illustrating a noise control method according to an exemplary embodiment of the present disclosure. This embodiment, applied to a noise control system (the noise control system including at least a first processing unit and a second processing unit), as shown in FIG. 2, includes the following step 201 to step 204, which are described below.

Step 201: Acquiring, by the first processing unit, at least one first reference acoustic signal and at least one error acoustic signal that correspond a first noise reduction cycle, where the at least one first reference acoustic signal is a noise signal acquired from at least one first position on a vehicle, and the at least one error acoustic signal is a noise residual signal acquired from at least one second position in a cockpit of the vehicle.

The first processing unit, representing a functional module for performing filtering processing on a reference acoustic signal, may include a digital signal processing unit, deployed as the DSP 104 shown in FIG. 1. The first processing unit may typically be a digital signal processing unit with high real-time performance, and configured for performing real-time filtering, data transmission, and other functions.

In this embodiment, a noise reduction cycle is used for indicating a time interval for noise reduction using same filter parameters. Filter parameters used for different noise reduction cycles may be different. However, for reference acoustic signals within one noise reduction cycle, the same filter parameters are used for performing signal filtering processing. The first noise reduction cycle may be a time period including a current moment.

The first reference acoustic signal is used for representing road noise in a traveling process of the vehicle, including, for example, noise generated by the contact between a tire and the ground, and/or noise generated by the tire itself. The first reference acoustic signal may be a noise signal acquired from at least one first position on the vehicle. The first position may be a position on a vehicle chassis or a position on an engine compartment in a vehicle body. At least one first sensor for acquiring the reference acoustic signal may be an accelerometer sensor or a sound pickup device such as a microphone.

The error acoustic signal is a noise residual signal acquired from at least one second position in the cockpit of the vehicle. The error acoustic signal may be acquired by at least one second sensor deployed in at least one second position, e.g., a sound pickup device such as a microphone. The second position typically refers to a position, inside the vehicle, that is relatively close to a human ear. The error acoustic signal is an error signal obtained by superimposing the noise signal (including the reference acoustic signal and other in-vehicle noise signals) and a noise control signal.

In this embodiment, after acquiring a first reference acoustic signal, each first sensor transmits the first reference acoustic signal to the first processing unit; and after acquiring an error acoustic signal, each second sensor transmits the error acoustic signal to the first processing unit. Then, at least one first reference acoustic signal and at least one error acoustic signal may be acquired by the first processing unit.

Step 202: Transmitting, by the first processing unit, the at least one first reference acoustic signal and the at least one error acoustic signal to the second processing unit.

The second processing unit, representing a functional module for updating filter parameters, may include a CPU, deployed as the CPU 105 shown in FIG. 1. The second processing unit may typically be a processing unit having a lower unit computing power cost than the first processing unit, including a CPU, an embedded processing unit (for example, an ARM cortex-r processing unit), and the like.

It should be noted that, “first” and “second” included in names of the first processing unit and the second processing unit are used only for distinguishing between their functions. In some cases, the first processing unit may typically be the above-mentioned high-performance processing unit with a higher unit computing power cost, and the second processing unit may be a processing unit with a lower unit computing power cost.

In this embodiment, the first processing unit and the second processing unit may communicate with each other through inter-core communication. The inter-core communication includes various types of implementations, involving a shared memory, a lock-free queue, and the like.

Specifically, the inter-core communication based on the shared memory involves implementing data exchange and communication by reading and writing data in a shared memory space to which the first processing unit and the second processing unit may access. The inter-core communication based on the lock-free queue involves implementing conflict-free data transmission between the first processing unit and the second processing unit based on a software-based parallel lock-free queue. For example, a linked-list-based concurrent ring queue (LCRQ) is a high-performance lock-free queue, ensuring, by a special algorithm and design, that the first processing unit and the second processing unit may concurrently access the queue without deadlock. This implementation is suitable for a scenario with a large amount of data and a relatively high requirement for real-time performance.

In some implementations, when the first processing unit transmits the at least one first reference acoustic signal and the at least one error acoustic signal to the second processing unit, the shared memory may be used to implement transmitting of data. That is, the at least one first reference acoustic signal and the at least one error acoustic signal are written to the shared memory, and the second processing unit acquires the at least one first reference acoustic signal and the at least one error acoustic signal by accessing the shared memory.

In some other implementations, when the first processing unit transmits the at least one first reference acoustic signal and the at least one error acoustic signal to the second processing unit, a lock-free queue may also be used to implement the transmitting of data. That is, the at least one first reference acoustic signal and the at least one error acoustic signal are written to the lock-free queue, and the second processing unit acquires the at least one first reference acoustic signal and the at least one error acoustic signal by subscribing to the lock-free queue.

Step 203: Updating, by the second processing unit, filter parameters based on the at least one first reference acoustic signal and the at least one error acoustic signal to obtain first filter parameters, and returning the first filter parameters to the first processing unit.

A filter is a frequency-selective device that allows specific frequency components in a signal to pass through while greatly attenuating other frequency components. Such a frequency selection function of the filter may be used to filter out interference noise or perform spectrum analysis. The filter used in this embodiment is an adaptive filter, which functions as an adaptive noise canceller in this embodiment. The operation of the adaptive filter involves two basic processes: a filtering process and an adaptive process. The filtering process is a convolution process of an input signal and filter parameters, for generating an output response to a series of input signals; and the adaptive process is to achieve adaptive adjustment of the filter parameters through a specific algorithm (different algorithms, such as filtered-x least mean square (FxLMS), filtered-x normalized least mean square (FxNLMS), filtered-x affine projection (FxAP), and filtered-x recursive least squares (FxRLS), may be selected according to needs) with the purpose of continuously reducing a mean square error between a response signal and a desired signal.

The FxLMS algorithm is an adaptive filter algorithm based on the minimum mean square error criterion, adjusting a coefficient of a filter by comparing a reference signal with a signal generated through filtering by the filter to minimize a mean square error of an error signal. The FxNLMS algorithm is an improved version of the FxLMS algorithm, with a normalization factor being introduced, for adaptively adjusting a step size value. Through the normalization factor, the FxNLMS algorithm may better adapt to different signal strengths and noise environments, thereby improving filtering performance. The FxAP algorithm is an affine projection algorithm with characteristics of data reuse, orthogonal projection in N gradient directions, and normalization processing, which is an algorithm that improves a convergence speed of an adaptive filter with a reference signal being correlated, achieving a balance between the convergence speed and an amount of misadjustment. The FxRLS algorithm is an adaptive filtering algorithm based on the least squares criterion, recursively updating filter parameters to minimize a mean square error of an error acoustic signal.

Through the above algorithms, such as FxNLMS, the filter parameters may be iteratively updated based on the at least one first reference acoustic signal and the at least one error acoustic signal until the filter parameters converge or a preset number of iterations is reached, to obtain the first filter parameters.

In this embodiment, after the first filter parameters are obtained, the first filter parameters may be transmitted to the first processing unit through inter-core communication.

Step 204: Performing, by the first processing unit based on the first filter parameters, filtering processing on at least one second reference acoustic signal corresponding to a second noise reduction cycle to obtain at least one noise control signal, and correspondingly transmitting the at least one noise control signal to at least one sound source corresponding to the at least one second position, so that the at least one sound source plays the corresponding noise control signal, where the second noise reduction cycle is a noise reduction cycle immediately after the first noise reduction cycle.

That the second noise reduction cycle is the noise reduction cycle immediately after the first noise reduction cycle, that is, the first filter parameters determined according to the at least one the reference acoustic signal and the at least one error acoustic signal that are acquired in the first noise reduction cycle is used for performing filtering processing on a reference acoustic signal of a next noise reduction cycle.

Optionally, filtering processing may be performed on a reference acoustic signal of the second noise reduction cycle by formula (1) to obtain a noise control signal y(n)=[y₀(n), y₀(n), . . . , y_{L-1}(n)], where L is a number of sound sources (the number of loudspeakers).

$${y}_{l} ( n ) = {\sum }_{m = o}^{M - 1} {W}_{lm} ( n ) * {x}_{m} ( n ) ∀ l ∈ \{ 0 , 1 , … , L - 1 \} \qquad formula ( 1 )$$

where yₗ(n) represents a noise control signal; obtained through filtering processing, for playing by a sound source I; n represents a time index after digital sampling of the reference acoustic signal; M represents the number of channels of a sensor acquiring the reference acoustic signal; Wₗₘ(n) represents a filter coefficient, with a matrix of L×M dimensions; xₘ(n) represents a reference acoustic signal from a channel of m; L represents the number of sound sources (the number of loudspeakers); and * represents a convolution operation.

Optionally, after a noise control signal corresponding to each sound source is determined, the corresponding noise control signal may be played inside the vehicle through a corresponding loudspeaker.

Through the above step 201 to step 204, in the noise control system, the first processing unit acquires at least one first reference acoustic signal and at least one error acoustic signal that correspond to the first noise reduction cycle, and transmits the at least one first reference acoustic signal and the at least one error acoustic signal to the second processing unit; the second processing unit updates filter parameters based on the at least one first reference acoustic signal and the at least one error acoustic signal update to obtain and return first filter parameters to the first processing unit; and thereby the first processing unit may perform, by using the first filter parameters, filtering processing on at least one second reference acoustic signal acquired within the second noise reduction cycle to obtain and transmit at least one noise control signal to at least one sound source corresponding to at least one second position, so that the at least one sound source plays the corresponding noise control signal to achieve noise control. In this way, in the technical solution of the present disclosure, noise control is achieved by the combination of the first processing unit and the second processing unit, thereby effectively expanding available computing power of the noise control system, and improving reliability and robustness of noise control. In addition, because the second processing unit has a relatively low unit computing power cost and is highly reusable, the implementation of some algorithms in noise control is migrated to the second processing unit, for example, filter parameter updating with a relatively low requirement for real-time performance is implemented by using the second processing unit, which helps reduce the cost of the noise control system. Meanwhile, signal filtering and output are implemented by using the first processing unit, which may ensure high real-time performance and a noise reduction effect of noise control.

FIG. 3 is a schematic flowchart illustrating a noise control method according to another exemplary embodiment of the present disclosure. As shown in FIG. 3, the method includes the following step 301 to step 307, which are described below.

Step 301: Acquiring, by a first processing unit, at least one first reference acoustic signal and at least one error acoustic signal that correspond a first noise reduction cycle.

The at least one first reference acoustic signal is a noise signal acquired from at least one first position on a vehicle, and the at least one error acoustic signal is a noise residual signal acquired from at least one second position in a cockpit of the vehicle.

In this embodiment, at least one first sensor is deployed in the at least one first position of the vehicle, the first reference acoustic signal in each first position is acquired by using each first sensor, and the acquired first reference acoustic signal is transmitted to the first processing unit. In this way, the first processing unit receives the at least one first reference acoustic signal correspondingly acquired by the at least one first sensor in the first noise reduction cycle. At least one second sensor is deployed in the at least one second position of the vehicle, an error acoustic signal in each second position is acquired by using each second sensor, and the acquired error acoustic signal is transmitted to the first processing unit. In this way, the first processing unit receives the at least one error acoustic signal correspondingly acquired by the at least one second sensor in the first noise reduction cycle.

For a specific implementation of step 301, refer to the description of step 201 of the embodiment shown in FIG. 2, details of which are not repeated herein.

Step 302: Writing, by the first processing unit, the at least one first reference acoustic signal and the at least one error acoustic signal to a shared memory, and transmitting a first notification message with address information carried therein to a second processing unit.

The shared memory, representing a storage area commonly accessed by the first processing unit and the second processing unit. In consideration of a relatively high frequency at which the first processing unit transmits the at least one first reference acoustic signal and the at least one error acoustic signal to the second processing unit, in order to prevent data loss caused by jitters in inter-core communication, in this embodiment, the at least one first reference acoustic signal and the at least one error acoustic signal are buffered preferably by a ring buffer mechanism, that is, a ring buffer is set in the shared memory, and the at least one first reference acoustic signal and the at least one error acoustic signal are buffered in the ring buffer. The ring buffer represents a data structure of a buffer with a fixed size and head-to-tail connection, suitable for buffering of data streams.

In some other optional implementations, a fixed-length buffer may also be used to buffer the at least one first reference acoustic signal and the at least one error acoustic signal, which is simple in structure, fast in reading and writing, and easy to manage.

In some other optional implementations, a chain buffer may also be used to buffer the at least one first reference acoustic signal and the at least one error acoustic signal. The chain buffer is dynamically expandable suitable for transmission requirements of different sizes of data transmission, with high flexibility.

In this embodiment, after data is written to the shared memory, a first notification message with address information for the written data carried therein may be transmitted to the second processing unit. For example, the first notification message is transmitted to the second processing unit by a mailbox mechanism Mailbox.

Step 303: Reading, by the second processing unit after receiving the first notification message, the at least one first reference acoustic signal and the at least one error acoustic signal from a storage space indicated by the address information of the shared memory.

After receiving the first notification message, the second processing unit parses the first notification message to obtain the address information, and then may read the at least one first reference acoustic signal and the at least one error acoustic signal from the storage space indicated by the address information.

Step 304: Updating, by the second processing unit, filter parameters based on the at least one first reference acoustic signal and the at least one error acoustic signal to obtain first filter parameters.

For a specific implementation of step 304, refer to the description of step 203 of the embodiment shown in FIG. 2, details of which are not repeated herein.

Step 305: Writing, by the second processing unit, the first filter parameters to a first buffer of a preset double-buffering area in the shared memory, and transmitting a second notification message to the first processing unit.

In consideration of a relatively long cycle of the filter parameters transmitted from the second processing unit to the first processing unit, the filter parameters are transmitted preferably through an A/B buffer. The A/B buffer relates to double buffering area, where one buffer is used by the first processing unit, and the other buffer is used by the second processing unit.

Exemplarily, after determining the first filter parameters, the second processing unit writes the first filter parameters to the first buffer and transmits the second notification message to the first processing unit, where information indicating that the first filter parameters have been written to the first buffer is carried in the second notification message. Then, the first buffer is switched from a state where writing is performed by the second processing unit to a state where the first filter parameters are to be read by the first processing unit. Before the first processing unit transmits, to the second processing unit, a response message indicating that the first filter parameters have been successfully read, the second processing unit cannot perform an operation on the first buffer, but may perform an operation only on a second buffer. After the first processing unit transmits, to the second processing unit, a response message indicating that the first filter parameters have been successfully read and successfully updated, the second processing unit may continue to perform an operation on the first buffer.

The second notification message may be a synchronization message, for indicating, to the first processing unit, that the filter parameters have been updated to the first buffer.

Step 306: Reading, by the first processing unit, the first filter parameters from the first buffer after the second notification message is received.

After receiving the second notification message, the first processing unit parses the second notification message to obtain an indication message for writing the first filter parameters to the first buffer, and then, the first processing unit may read the corresponding first filter parameters from the first buffer, replace original filter parameters with the first filter parameters, and perform, by using the first filter parameters, filtering processing on at least one second reference acoustic signal corresponding to a second noise reduction cycle.

Step 307: Performing, by the first processing unit based on the first filter parameters, filtering processing on at least one second reference acoustic signal corresponding to a second noise reduction cycle to obtain at least one noise control signal, and correspondingly transmitting the at least one noise control signal to at least one sound source corresponding to at least one second position, so that the at least one sound source plays the corresponding noise control signal, where the second noise reduction cycle is a noise reduction cycle immediately after the first noise reduction cycle.

For a specific implementation of step 307, refer to the description of step 204 of the embodiment shown in FIG. 2, details of which are not repeated herein.

Through the above step 301 to step 307, a specific implementation of transmitting data between the first processing unit and the second processing unit through inter-core communication is disclosed. The first processing unit writes at least one first reference acoustic signal and at least one error acoustic signal to the shared memory, and transmits a first notification message with address information carried therein to the second processing unit. After receiving the first notification message, the second processing unit reads the at least one first reference acoustic signal and the at least one error acoustic signal from a storage space indicated by the address information of the shared memory, updates filter parameters based on the at least one first reference acoustic signal and the at least one error acoustic signal to obtain first filter parameters, then writes the first filter parameters to a first buffer of a preset double-buffering area in the shared memory, and transmits a second notification message to the first processing unit. After receiving the second notification message, the first processing unit reads the first filter parameters from the first buffer, performs, based on the first filter parameters, filtering processing on at least one second reference acoustic signal corresponding to a second noise reduction cycle to obtain and correspondingly transmits at least one noise control signal to at least one sound source corresponding to at least one second position, so that the at least one sound source plays the corresponding noise control signal. In this way, the technical solution of the present disclosure achieves data exchange between the first processing unit and the second processing unit through inter-core communication. In addition, according to characteristics of data transmission between the first processing unit and the second processing unit, a ring buffer mechanism is preferably used when the first processing unit transmits data to the second processing unit, to prevent data loss caused by jitters in inter-core communication, and a double-buffering area mechanism is preferably used when the second processing unit transmits data to the first processing unit. Through alternating operation between two independent buffers, contention for read and write operations is reduced, thereby improving concurrent read and write efficiency, helping prevent data loss, and ensuring complete data transmission.

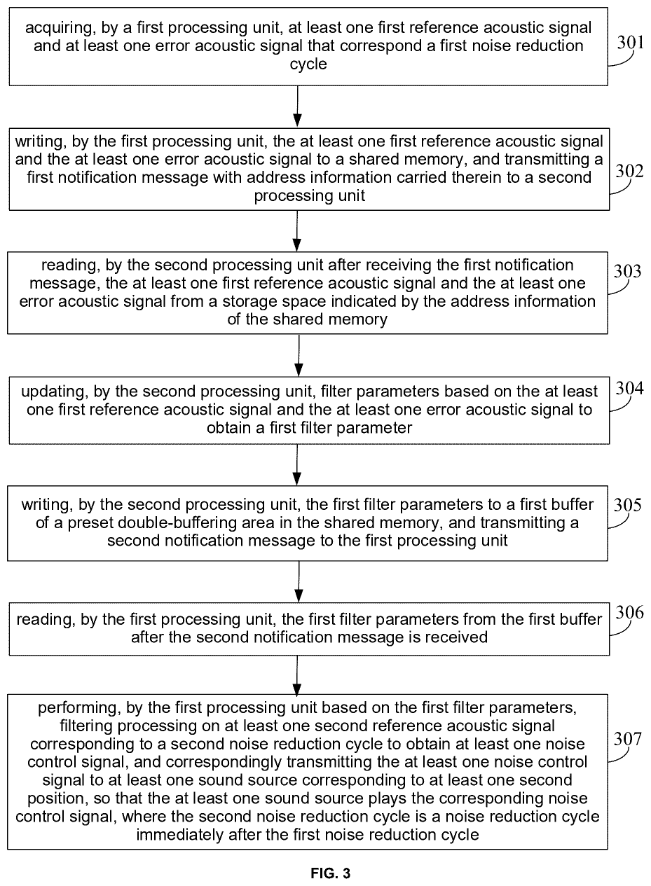

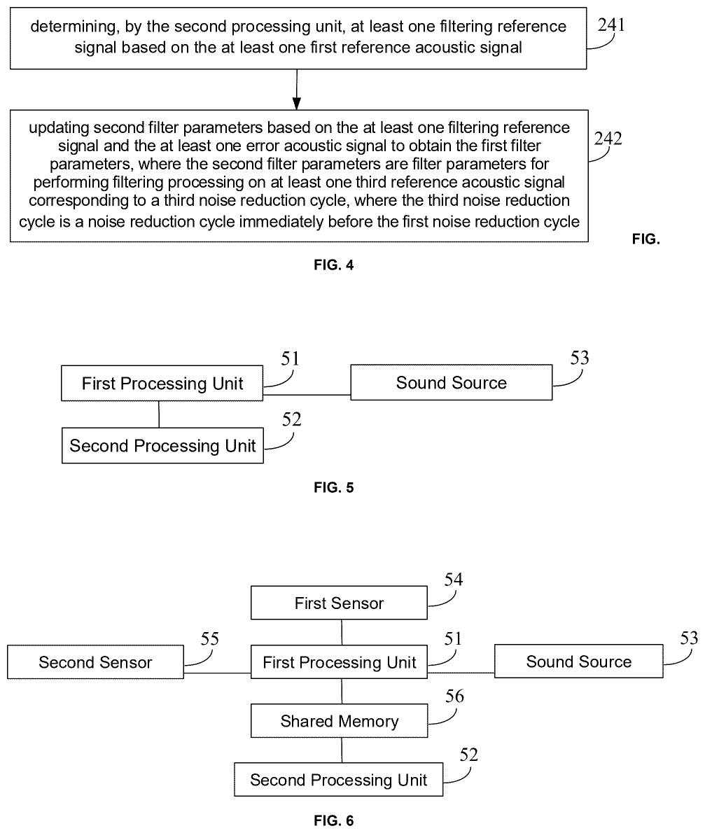

FIG. 4 is a schematic flowchart illustrating filter parameter update in a noise control method according to another exemplary embodiment of the present disclosure. Based on the foregoing embodiment shown in FIG. 2, step 204 includes step 241 and step 242, which are described below.

Step 241: Determining, by the second processing unit, at least one filtering reference signal based on the at least one first reference acoustic signal.

There are different propagation path for the first reference acoustic signal. Therefore, different signals may be acquired in different positions. Sound pickup devices (such as a microphone and an accelerometer sensor) are arranged in different positions of the vehicle to pick up noise signals to obtain a filtering reference signal and an error signal. For example, an accelerometer sensor is arranged at the bottom of the vehicle to obtain a reference acoustic signal, and a microphone is arranged inside the vehicle to obtain an error acoustic signal.

In this embodiment, the first noise signal is filtered by using an estimation filter to determine a filtering reference signal, where the estimation filter is a filter s(n) corresponding to a secondary path. An estimation process of the filter may be obtained by offline modeling or online modeling. For example, white noise is played, and the white noise signal emitted out and a signal received from the end of the secondary path are processed by a Wiener algorithm to determine a relative filter between both of them as the estimation filter. In this embodiment, the secondary path represents a propagation path from the loudspeaker inside the vehicle to the second sensor.

In this embodiment, filtering of the first reference acoustic signal compensates for consumption of the first reference acoustic signal caused by propagation on the secondary path and reduces a transmission error, thereby improving accuracy in updating the filter.

Step 242: Updating second filter parameters based on the at least one filtering reference signal and the at least one error acoustic signal to obtain the first filter parameters, where the second filter parameters are filter parameters for performing filtering processing on at least one third reference acoustic signal corresponding to a third noise reduction cycle, where the third noise reduction cycle is a noise reduction cycle immediately before the first noise reduction cycle.

In this embodiment, a difference between the first filter parameters after the update and the second filter parameters before the update falls within a preset range. That is, a difference between the first filter parameters and the second filter parameters falls within a preset range. The adaptive filtering algorithm is a commonly used algorithm for in-vehicle active noise reduction. In this embodiment, the adaptive filtering algorithm may include FxLMS, FxNLMS, FxAP, FxRLS, or other algorithms. In the adaptive filtering algorithm, after the filtering reference signal and the error acoustic signal are received, the filter parameters are iteratively updated.

In this embodiment, any adaptive filtering algorithm may be selected for implementing the update of the filter parameters. A least mean square (LMS) algorithm are used as an example for description below. The LMS algorithm is a common adaptive filter algorithm that iteratively updates filter parameters so that an output of the filter is as close to a desired signal as possible. A formula for iteratively updating the filter parameters is shown by formula (2):

$$w ( n + 1 ) = w ( n ) + μ ( n ) e ( n ) r ( n ) \qquad formula ( 2 )$$

In formula (2), w(n+1) represents the first filter parameters after the update; w(n) represents the second filter parameters before the update; μ(n)e(n)r(n) represents a parameter update amount; and r(n) represents the filtering reference signal, e(n) represents the error acoustic signal, and u (n) represents an update step size value.

In this embodiment, based on at least one first reference acoustic signal acquired from different positions in the vehicle, in combination with consumption of each first reference acoustic signal on a propagation path, a corresponding filtering reference signal r(n) is determined. In this way, the second filter parameters before update may be updated based on the filtering reference signal, the error acoustic signal, and the second filter parameters before the update, to obtain first filter parameters after the update, thereby implementing adaptive updating of the filter parameters, ensuring a best filtering effect, and ensuring that signal filtering has higher versatility and flexibility in the noise control system.

### Exemplary Apparatus

FIG. 5 is a schematic block diagram illustrating a structure of a noise control apparatus according to an exemplary embodiment of the present disclosure. As shown in FIG. 5, the apparatus provided in this embodiment includes a first processing unit 51, a second processing unit 52, and at least one sound source 53.

The first processing unit 51 is configured for acquiring at least one first reference acoustic signal and at least one error acoustic signal that correspond to a first noise reduction cycle, where the at least one first reference acoustic signal is a noise signal acquired from at least one first position on a vehicle, and the at least one error acoustic signal is a noise residual signal acquired from at least one second position in a cockpit of the vehicle.

The first processing unit 51 is configured for transmitting the at least one first reference acoustic signal and the at least one error acoustic signal to the second processing unit 52.

The second processing unit 52 is configured for updating filter parameters based on the at least one first reference acoustic signal and the at least one error acoustic signal to obtain first filter parameters, and returning the first filter parameters to the first processing unit 51.

The first processing unit 51 is configured for performing, based on the first filter parameters, filtering processing on at least one second reference acoustic signal corresponding to a second noise reduction cycle to obtain at least one noise control signal, and correspondingly transmitting the at least one noise control signal to the at least one sound source 53 corresponding to the at least one second position, so that the at least one sound source 53 plays the corresponding noise control signal, where the second noise reduction cycle is a noise reduction cycle immediately after the first noise reduction cycle.

The first processing unit 51, representing a functional module for performing filtering processing on a reference acoustic signal, and may be deployed as the DSP 104 shown in FIG. 1. The first processing unit may typically be a digital signal processing unit with high real-time performance, and configured for performing real-time filtering, data transmission, and other functions.

The second processing unit 52, representing a functional module for updating filter parameters, may be deployed as the CPU 105 shown in FIG. 1. The second processing unit may typically be a processing unit having a lower unit computing power cost than the first processing unit, including a CPU, an embedded processing unit (for example, an ARM cortex-r processing unit), and the like.

In the noise control apparatus provided in the foregoing embodiment of the present disclosure, noise control is achieved by the combination of the first processing unit and the second processing unit, thereby effectively expanding available computing power of a noise control system, and improving reliability and robustness of noise control. In addition, because the second processing unit has a relatively low unit computing power cost and is highly reusable, implementing filter parameter updating with a relatively low requirement for real-time performance by using the second processing unit helps reduce the cost of the system. Meanwhile, implementing signal filtering and output by using the first processing unit may ensure high real-time performance and a noise reduction effect of noise control.

FIG. 6 is a schematic block diagram illustrating a structure of a noise control apparatus according to another exemplary embodiment of the present disclosure. As shown in FIG. 6, based on the foregoing embodiment shown in FIG. 5, the apparatus further includes at least one first sensor 54 and at least one second sensor 55.

The at least one first sensor 54 is configured for correspondingly acquiring the at least one first reference acoustic signal within the first noise reduction cycle, and transmitting the at least one first reference acoustic signal to the first processing unit 51, where the at least one first sensor 54 is correspondingly deployed in the at least one first position on the vehicle.

The at least one second sensor 55 is configured for correspondingly acquiring the at least one error acoustic signal within the first noise reduction cycle, and transmitting the at least one error acoustic signal to the first processing unit 51, where the at least one second sensor 55 is correspondingly deployed in the at least one second position in the cockpit of the vehicle.

The first sensor in this embodiment may be an accelerometer sensor or a sensor capable of picking up an audio signal, such as a microphone. The second sensor in this embodiment may be a sensor capable of picking up an audio signal, such as a microphone.

In some embodiments, the apparatus further includes a shared memory 56.

The shared memory 56 provides a data reading service and a data writing service for the first processing unit 51 and the second processing unit 52.

The shared memory 56 is configured for buffering the at least one first reference acoustic signal and the at least one error acoustic signal that are written by the first processing unit 51 and buffering the first filter parameters written by the second processing unit 52.

It should be noted that, the modules in this apparatus may be decomposed and/or recombined. These decompositions and/or recombinations should be considered as equivalent solutions of this apparatus.

The exemplary embodiment of this apparatus partially corresponds to the exemplary method section described above, and relevant contents may be referenced and quoted to each other. For beneficial technical effects corresponding to the exemplary embodiment of this apparatus, refer to the corresponding beneficial technical effects of the exemplary method section described above, which are not repeated herein.

### Exemplary Chip

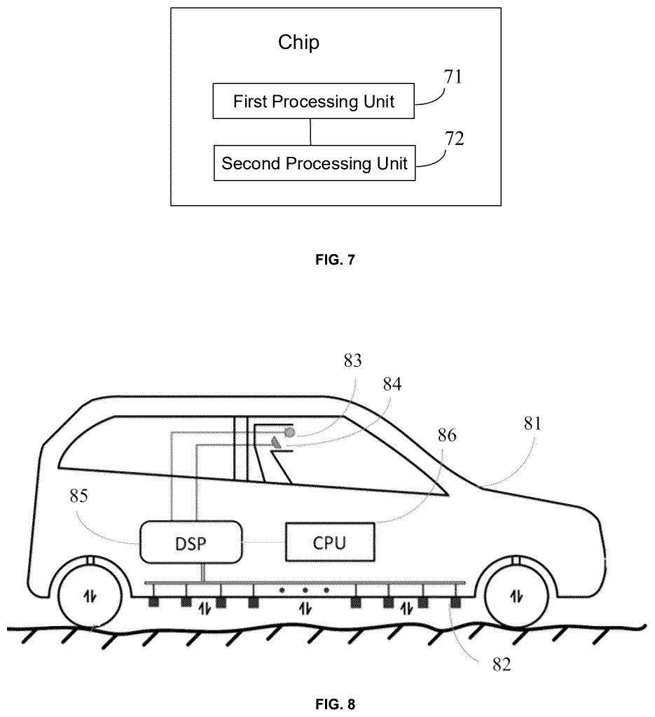

FIG. 7 is a schematic block diagram illustrating a structure of a chip for noise control according to another exemplary embodiment of the present disclosure. As shown in FIG. 7, the chip for noise control includes a first processing unit 71 and a second processing unit 72, which are connected to each other through an inter-core communication link.

The first processing unit 71 is configured for acquiring at least one first reference acoustic signal and at least one error acoustic signal that correspond to a first noise reduction cycle, where the at least one first reference acoustic signal is a noise signal acquired from at least one first position on a vehicle, and the at least one error acoustic signal is a noise residual signal acquired from at least one second position in a cockpit of the vehicle.

The first processing unit 71 is configured for transmitting the at least one first reference acoustic signal and the at least one error acoustic signal to the second processing unit 72.

The second processing unit 72 is configured for updating filter parameters based on the at least one first reference acoustic signal and the at least one error acoustic signal to obtain first filter parameters, and returning the first filter parameters to the first processing unit 71.

The first processing unit 71 is configured for performing, based on the first filter parameters, filtering processing on at least one second reference acoustic signal corresponding to a second noise reduction cycle to obtain at least one noise control signal, and correspondingly transmitting the at least one noise control signal to at least one sound source corresponding to the at least one second position, so that the at least one sound source plays the corresponding noise control signal, where the second noise reduction cycle is a noise reduction cycle immediately after the first noise reduction cycle.

In the chip provided in the foregoing embodiment of the present disclosure, noise control is achieved by the combination of the first processing unit and the second processing unit, thereby effectively expanding available computing power of a noise control system, and improving reliability and robustness of noise control. In addition, because the second processing unit has a relatively low unit computing power cost and is highly reusable, the implementation of some algorithms in noise control is migrated to the second processing unit, for example, filter parameter updating with a relatively low requirement for real-time performance is implemented by using the second processing unit, which helps reduce the cost of the noise control system. Meanwhile, signal filtering and output are implemented by using the first processing unit, which may ensure high real-time performance and a noise reduction effect of noise control.

### Exemplary Vehicle

FIG. 8 is a schematic diagram illustrating a vehicle with a noise control function according to another exemplary embodiment of the present disclosure. As shown in FIG. 8, the vehicle includes a vehicle body 81, at least one first sensor 82, at least one second sensor 83, at least one sound source 84, and a noise control apparatus including a DSP 85 and a CPU 86, or the chip in FIG. 7.

The at least one first sensor 82 is deployed in at least one first position on the vehicle body 81. The at least one second sensor 83 is deployed in at least one second position in the vehicle body. The at least one sound source 84 is deployed in the at least one second position in the vehicle body.

The at least one first sensor 82 is deployed in at least one first position of a vehicle bottom of the vehicle body or of an engine compartment. The at least one second sensor 83 is deployed in at least one second position in a cockpit of the vehicle body. The at least one sound source is deployed in a position, corresponding to the at least one second position, in the cockpit of the vehicle body.

### Exemplary Electronic Device

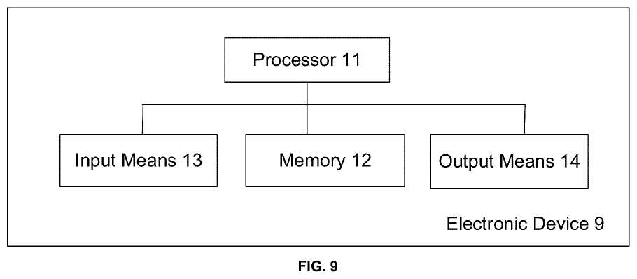

FIG. 9 is a schematic block diagram illustrating a structure of an electronic device according to an embodiment of the present disclosure. The electronic device includes a plurality of processors 11 and a memory 12.

The processor 11 may be a CPU or another form of processing unit having a data processing capability and/or an instruction execution capability, and may control another component in the electronic device 9 to perform a desired function.

The memory 12 may include one or more computer program products. The computer program product may include various forms of computer readable storage mediums, such as a volatile memory and/or a non-volatile memory. The volatile memory may include, for example, a random access memory (RAM) and/or a cache. The non-volatile memory may include, for example, a read-only memory (ROM), a hard disk, or a flash memory. The computer readable storage medium may store one or more computer program instructions. The processor 11 may run the one or more computer program instructions to implement the vehicle posture detection method and/or other desired functions in the foregoing embodiments of the present disclosure.

In an example, the electronic device may further include: an input means 13 and an output means 14. The components are interconnected through a bus system and/or other forms of connection mechanisms (not shown).

The input means 13 may further include, for example, a keyboard, a mouse, a touchscreen, or a sound pickup device (such as a microphone array).

The output means 14 may output various information to the outside, and may include, for example, a display, a loudspeaker, a printer, and a communication network and a remote output means connected thereto.

Certainly, for simplicity, only some components in the electronic device that are related to the present disclosure are shown in FIG. 9, and components such as a bus and an input/output interface are omitted. Besides, the electronic device may further include any other appropriate components depending on specific applications.

Exemplary Computer Program Product And Computer Readable Storage

### Medium

In addition to the foregoing method and device, the embodiments of the present disclosure may also provide a computer program product including computer program instructions that, when run by a processor, cause the processor to perform the steps of the noise control method according to the embodiments of the present disclosure that is described in the foregoing “exemplary method” section of this specification.

The computer program product may be program code, written with one or any combination of a plurality of programming languages, which is configured to perform the operations in the embodiments of the present disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of the present disclosure may further relate to a computer readable storage medium, on which computer program instructions are stored. The computer program instructions, when run by a processor, cause the processor to perform the steps of the noise control method according to the embodiments of the present disclosure that is described in the foregoing “exemplary method” section of this specification.

The computer-readable storage medium may be any combination of one or more readable mediums. The readable medium may be a readable signal medium or a readable storage medium. The readable storage medium may include, for example, but is not limited to electrical, magnetic, optical, electromagnetic, infrared, or semiconductor systems, apparatuses, or devices, or any combination of the above. More specific examples (a non-exhaustive list) of the readable storage medium include: an electrical connection with one or more conducting wires, a portable disk, a hard disk, a RAM, a ROM, an erasable programmable ROM (EPROM or flash memory), an optical fiber, a portable compact disk ROM (CD-ROM), an optical storage device, a magnetic storage device, or any suitable combination of the above.

Basic principles of the present disclosure are described above in combination with specific embodiments. However, it should be pointed out that the advantages, superiorities, effects, and the like mentioned in the present disclosure are merely examples rather than limitations, and it should not be considered that these advantages, superiorities, effects, and the like are necessary for each of the embodiments of the present disclosure. In addition, specific details described above are merely for examples and for ease of understanding, rather than limitations. The details described above do not limit that the present disclosure must be implemented by using the foregoing specific details.

The embodiments in this specification are described in a progressive manner, each embodiment focuses on differences from other embodiments, and the same or similar parts between the embodiments may be referred to each other. The system embodiment is described in a relatively simple way as it basically corresponds to the method embodiment. For related parts, refer to the partial description of the method embodiment.

The block diagrams of the means, apparatus, devices, and systems involved in the present disclosure are provided as illustrative examples only, and it is not intended to require or imply that they should be connected, arranged, or configured in the manner illustrated in the block diagrams. As a person skilled in the art will appreciate, these means, apparatuses, devices, and systems may be connected, arranged, or configured in any manner. Terms such as “including”, “containing”, and “having” are open-ended terms, and refer to and may be used interchangeably with “including but not limited to”. The terms “or” and “and” as used herein refer to and may be used interchangeably with the term “and/or”, unless otherwise clearly stated in the context. The term “such as” as used herein refers to and may be used interchangeably with the term “such as, but not limited to”.

The methods and apparatuses of the present disclosure may be implemented in many ways. For example, the methods and apparatuses of the present disclosure may be implemented by software, hardware, firmware, or any combination of software, hardware, and firmware. The above sequence of steps for use in the method is for illustrative purposes only. The steps of the method of the present disclosure are not limited to the sequence specifically described above, unless otherwise specifically stated. In addition, in some embodiments, the present disclosure may alternatively be implemented as programs recorded in a recording medium, and the programs include machine-readable instructions for implementing the methods according to the present disclosure. Therefore, the present disclosure also covers a recording medium storing programs for performing the methods according to the present disclosure.

It should also be noted that, in the apparatuses, devices, and methods of the present disclosure, each component or each step may be decomposed and/or recombined. These decompositions and/or recombinations should be considered equivalent solutions of the present disclosure.

The above description of the disclosed aspects is provided to enable a person skilled in the art to make or use the present disclosure. Various modifications to these aspects will be readily apparent to a person skilled in the art, and the generic principles defined herein may be applied to other aspects without departing from the scope of the present disclosure. Therefore, the present disclosure is not intended to be limited to the aspects shown herein, but rather to the widest scope consistent with the principles and novel features disclosed herein.

The above description has been given for the purposes of illustration and description. In addition, this description is not intended to limit the embodiments of the present disclosure to the forms disclosed herein. Although a plurality of exemplary aspects and embodiments have been discussed above, a person skilled in the art will figure out certain variations, modifications, changes, additions, and subcombinations thereof.

What is claimed is:

1. A noise control method, comprising:
acquiring, by a first processing unit, at least one first reference acoustic signal and at least one error acoustic signal that correspond to a first noise reduction cycle, wherein the at least one first reference acoustic signal is a noise signal acquired from at least one first position on a vehicle, and the at least one error acoustic signal is a noise residual signal acquired from at least one second position in a cockpit of the vehicle;
transmitting, by the first processing unit, the at least one first reference acoustic signal and the at least one error acoustic signal to a second processing unit;
updating, by the second processing unit, filter parameters based on the at least one first reference acoustic signal and the at least one error acoustic signal to obtain first filter parameters, and returning the first filter parameters to the first processing unit; and
performing, by the first processing unit based on the first filter parameters, filtering processing on at least one second reference acoustic signal corresponding to a second noise reduction cycle to obtain at least one noise control signal, and correspondingly transmitting the at least one noise control signal to at least one sound source corresponding to the at least one second position, so that the at least one sound source plays the corresponding noise control signal, wherein the second noise reduction cycle is a noise reduction cycle immediately after the first noise reduction cycle.

2. The method according to claim 1, wherein the first processing unit comprises a digital signal processing unit; and
the second processing unit comprises a central processing unit (CPU).

3. The method according to claim 1, wherein the transmitting, by the first processing unit, the at least one first reference acoustic signal and the at least one error acoustic signal to a second processing unit comprises:
transmitting, by the first processing unit, the at least one first reference acoustic signal and the at least one error acoustic signal to the second processing unit through inter-core communication; and
the returning the first filter parameters to the first processing unit comprises:
returning the first filter parameters to the first processing unit through inter-core communication.

4. The method according to claim 3, wherein the transmitting, by the first processing unit, the at least one first reference acoustic signal and the at least one error acoustic signal to the second processing unit through inter-core communication comprises:
writing, by the first processing unit, the at least one first reference acoustic signal and the at least one error acoustic signal to a shared memory, and transmitting a first notification message with address information carried therein to the second processing unit, so that the second processing unit reads, after receiving the first notification message, the at least one first reference acoustic signal and the at least one error acoustic signal from a storage space indicated by the address information of the shared memory.

5. The method according to claim 3, wherein the returning the first filter parameters to the first processing unit through inter-core communication comprises:
writing the first filter parameters to a first buffer of a preset double-buffering area in a shared memory, and transmitting a second notification message to the first processing unit, so that the first processing unit reads the first filter parameters from the first buffer after receiving the second notification message.

6. The method according to claim 1, wherein the acquiring, by a first processing unit, at least one first reference acoustic signal and at least one error acoustic signal that correspond to a first noise reduction cycle comprises:
receiving, by the first processing unit, the at least one first reference acoustic signal correspondingly acquired by at least one first sensor within the first noise reduction cycle, wherein the at least one first sensor is correspondingly deployed in the at least one first position on the vehicle; and
receiving, by the first processing unit, the at least one error acoustic signal correspondingly acquired by at least one second sensor within the first noise reduction cycle, wherein the at least one second sensor is correspondingly deployed in the at least one second position in the cockpit of the vehicle.

7. The method according to claim 1, wherein the updating, by the second processing unit, filter parameters based on the at least one first reference acoustic signal and the at least one error acoustic signal to obtain first filter parameters comprises:
determining, by the second processing unit, at least one filtering reference signal based on the at least one first reference acoustic signal; and
updating second filter parameters based on the at least one filtering reference signal and the at least one error acoustic signal to obtain the first filter parameters, wherein the second filter parameters are filter parameters for performing filtering processing on at least one third reference acoustic signal corresponding to a third noise reduction cycle, the third noise reduction cycle being a noise reduction cycle immediately before the first noise reduction cycle.

8. The method according to claim 2, wherein the transmitting, by the first processing unit, the at least one first reference acoustic signal and the at least one error acoustic signal to a second processing unit comprises:
transmitting, by the first processing unit, the at least one first reference acoustic signal and the at least one error acoustic signal to the second processing unit through inter-core communication; and
the returning the first filter parameters to the first processing unit comprises:
returning the first filter parameters to the first processing unit through inter-core communication.

9. The method according to claim 2, wherein the acquiring, by a first processing unit, at least one first reference acoustic signal and at least one error acoustic signal that correspond to a first noise reduction cycle comprises:
receiving, by the first processing unit, the at least one first reference acoustic signal correspondingly acquired by at least one first sensor within the first noise reduction cycle, wherein the at least one first sensor is correspondingly deployed in the at least one first position on the vehicle; and
receiving, by the first processing unit, the at least one error acoustic signal correspondingly acquired by at least one second sensor within the first noise reduction cycle, wherein the at least one second sensor is correspondingly deployed in the at least one second position in the cockpit of the vehicle.

10. The method according to claim 2, wherein the updating, by the second processing unit, filter parameters based on the at least one first reference acoustic signal and the at least one error acoustic signal to obtain first filter parameters comprises:
determining, by the second processing unit, at least one filtering reference signal based on the at least one first reference acoustic signal; and
updating second filter parameters based on the at least one filtering reference signal and the at least one error acoustic signal to obtain the first filter parameters, wherein the second filter parameters are filter parameters for performing filtering processing on at least one third reference acoustic signal corresponding to a third noise reduction cycle, the third noise reduction cycle being a noise reduction cycle immediately before the first noise reduction cycle.

11. A noise control apparatus, comprising: a first processing unit and a second processing unit, wherein the first processing unit and the second processing unit are connected to each other through an inter-core communication link;
the first processing unit is configured for acquiring at least one first reference acoustic signal and at least one error acoustic signal that correspond to a first noise reduction cycle, wherein the at least one first reference acoustic signal is a noise signal acquired from at least one first position on a vehicle, and the at least one error acoustic signal is a noise residual signal acquired from at least one second position in a cockpit of the vehicle;
the first processing unit is configured for transmitting the at least one first reference acoustic signal and the at least one error acoustic signal to the second processing unit;
the second processing unit is configured for updating filter parameters based on the at least one first reference acoustic signal and the at least one error acoustic signal to obtain first filter parameters, and returning the first filter parameters to the first processing unit; and
the first processing unit is configured for performing, based on the first filter parameters, filtering processing on at least one second reference acoustic signal corresponding to a second noise reduction cycle to obtain at least one noise control signal, and correspondingly transmitting the at least one noise control signal to at least one sound source corresponding to the at least one second position, so that the at least one sound source plays the corresponding noise control signal, wherein the second noise reduction cycle is a noise reduction cycle immediately after the first noise reduction cycle.

12. The apparatus according to claim 11, further comprising: at least one first sensor and at least one second sensor, wherein
the at least one first sensor is configured for correspondingly acquiring the at least one first reference acoustic signal within the first noise reduction cycle, and transmitting the at least one first reference acoustic signal to the first processing unit, wherein the at least one first sensor is correspondingly deployed in the at least one first position on the vehicle; and
the at least one second sensor is configured for correspondingly acquiring the at least one error acoustic signal within the first noise reduction cycle, and transmitting the at least one error acoustic signal to the first processing unit, wherein the at least one second sensor is correspondingly deployed in the at least one second position in the cockpit of the vehicle.

13. The apparatus according to claim 11, further comprising: a shared memory, wherein
the shared memory provides a data reading service and a data writing service for the first processing unit and the second processing unit; and
the shared memory is configured for buffering the at least one first reference acoustic signal and the at least one error acoustic signal that are written by the first processing unit and buffering the first filter parameters written by the second processing unit.

14. The apparatus according to claim 12, further comprising: a shared memory, wherein
the shared memory provides a data reading service and a data writing service for the first processing unit and the second processing unit; and
the shared memory is configured for buffering the at least one first reference acoustic signal and the at least one error acoustic signal that are written by the first processing unit and buffering the first filter parameters written by the second processing unit.

15. A chip, comprising a first processing unit and a second processing unit, wherein the first processing unit and the second unit are connected to each other through an inter-core communication link;
the first processing unit is configured for acquiring at least one first reference acoustic signal and at least one error acoustic signal that correspond to a first noise reduction cycle, wherein the at least one first reference acoustic signal is a noise signal acquired from at least one first position on a vehicle, and the at least one error acoustic signal is a noise residual signal acquired from at least one second position in a cockpit of the vehicle;
the first processing unit is configured for transmitting the at least one first reference acoustic signal and the at least one error acoustic signal to the second processing unit;
the second processing unit is configured for updating filter parameters based on the at least one first reference acoustic signal and the at least one error acoustic signal to obtain first filter parameters, and returning the first filter parameters to the first processing unit; and
the first processing unit is configured for performing, based on the first filter parameters, filtering processing on at least one second reference acoustic signal corresponding to a second noise reduction cycle to obtain at least one noise control signal, and correspondingly transmitting the at least one noise control signal to at least one sound source corresponding to the at least one second position, so that the at least one sound source plays the corresponding noise control signal, the second noise reduction cycle being a noise reduction cycle immediately after the first noise reduction cycle.

16. A vehicle, comprising: a vehicle body, at least one first sensor, at least one second sensor, at least one sound source, and the noise control apparatus according to claim 11, wherein
the at least one first sensor is deployed in the at least one first position on the vehicle body;
the at least one second sensor is deployed in the at least one second position in the vehicle body; and
the at least one sound source is deployed in the at least one second position in the vehicle body.

17. The vehicle according to claim 16, wherein the at least one first sensor is deployed in at least one first position of a vehicle bottom of the vehicle body or of an engine compartment;
the at least one second sensor is deployed in at least one second position in a cockpit of the vehicle body; and
the at least one sound source is deployed in a position, corresponding to the at least one second position, in the cockpit of the vehicle body.

18. A vehicle, comprising: a vehicle body, at least one first sensor, at least one second sensor, at least one sound source, and the noise control apparatus according to claim 12, wherein
the at least one first sensor is deployed in the at least one first position on the vehicle body;
the at least one second sensor is deployed in the at least one second position in the vehicle body; and
the at least one sound source is deployed in the at least one second position in the vehicle body.

19. A vehicle, comprising: a vehicle body, at least one first sensor, at least one second sensor, at least one sound source, and the noise control apparatus according to claim 13, wherein
the at least one first sensor is deployed in the at least one first position on the vehicle body;
the at least one second sensor is deployed in the at least one second position in the vehicle body; and
the at least one sound source is deployed in the at least one second position in the vehicle body.

20. A vehicle, comprising: a vehicle body, at least one first sensor, at least one second sensor, at least one sound source, and the chip according to claim 15, wherein
the at least one first sensor is deployed in the at least one first position on the vehicle body,
the at least one second sensor is deployed in the at least one second position in the vehicle body, and
the at least one sound source is deployed in the at least one second position in the vehicle body.
